(19) United States
(12) Patent Application Publication
(10) Pub. No.: US 2012/0296988 A1
(43) Pub. Date: Nov. 22, 2012

(54) EMAIL SPAM ELIMINATION USING PER-CONTACT ADDRESS

(76) Inventor: Bharath R Rao, (US)

(21) Appl. No.: 13/113,058

(22) Filed: May 22, 2011

(51) Int. Cl. G06F 15/16

(52) U.S. Cl. 709/206

(57) ABSTRACT

A method and system to transparently generate or manually allocate an authorized email address per contact and accept email sent to the authorized email address from the contact. If an authorized email address is leaked, it will be detected quickly, revoked and the assignee of the authorized email will be notified. When one of the user's contacts has sent an email to multiple recipients including the user, replies to the present conversation are allowed from other recipients. The user can generate a few open addresses that can receive email from any address. This allows the user to post email addresses on print or electronic publications and websites to allow readers to send email. This address could be revoked after a certain point in time or expire after an allocated lifetime.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention is in the technical field of email messages. More particularly, the present invention is in the technical field of detecting and eliminating Undesirable email (Spam). More particularly, one where email is accepted only from authorized senders (whitelisting).

Undesirable email or “SPAM” is an unsolved problem since at least 1995. Many solutions have been proposed but have all been partially or completely ineffective. The most pervasive methods today involve scanning and analyzing the content of the message and calculating the probability of the message being spam. This and other probabilistic methods have failed or partially failed because they not only carry the risk of false positives and negatives, but require the mail server to read in the entire message and store it on their server and also place the message in the user's spam folder. While they reduce the user's burden of sorting through spam, these methods do not reduce the bandwidth, storage and computational cost of handling spam. Other methods have failed because they require changes to the SMTP email protocol or additional processes and servers that would break compatibility with many existing email servers. Such technologies include e-stamp, methods forcing the sender to compute hash collisions, third party verification, etc. Many others require a modification in user behavior such as having the add tokens to the email headers or body, responding to a challenge and users generally resist any system that forces them to do additional work.

Most anti-spam measures are likely to fail because the very attributes that make email useful also make it easy to spam. The very fact that there is an email address that anyone could send email to makes it simply a matter of time that the address will fall into the hands of spammers.

A whitelisting system is one where the email system that only accepts emails from a preselected list of senders, which could simply be the user's contact list. Whitelisting systems reduce the amount of spam but they do so by also reducing the usability of email. Whitelisting makes it impractical to place the user's email address in a publication or print an email address on a business card and give it to a new business lead. To some extent, requiring a challenge-response test to enable a non-whitelisted sender to send email may help guard against spam, but they are not entirely effective since even if a small fraction of the challenge-response tests are machine solvable, the spam goes through. As challenge-response tests for new senders increases in popularity, spammers will certainly try to solve these tests and resend the spam email indefinitely as they now do with websites. Recently, these tests have been farmed off to human solvers in exchange for small rewards rendering whitelisting with a challenge-response barrier at least partially ineffective.

Whitelisting also assumes emails only occur between two parties and makes multi-user communication cumbersome. For example, such a system would not allow a conversation between a group of friends since a friend of the original sender who is not on the user's whitelist cannot simply Reply-All and have the conversation continue. A challenge-response test to a group conversation is impractical and breaks the natural flow of conversation if one of the recipients replies and is issued a challenge-response test and is unable or unwilling to follow through.

The biggest problem with whitelisting is that it does not stop spam that appears to have been sent from one of your contacts. Spam is often sent using trojans or malicious scripts that have access to the user's contact list and a spam message is sent using one of the user's contacts as the sender.

### TERMINOLOGY

This section defines the terminology used in the rest of this document.
1. Simple Mail Transport Protocol (SMTP)—The standard protocol defined in RFC 821 used to send and receive email across computer networks, including the Internet. As used herein, SMTP also refers to ESMTP (Extended SMTP) defined in RFC 1869, RFC 5321 and successors.
2. Contact—A person or other entity that the user of this system wishes to communicate via email.
3. Authorized address—An email address that the system will accept email for, while rejecting others.
4. Assignment and Assignee—Instructing the system to accept emails from a specified contact to a specified authorized address is termed assignment. The contact's email address that was assigned the authorized address is termed the assignee of the authorized address.
5. Leak—When someone other than the assignee sends an email to an authorized address, the authorized address is designated as ‘Leaked’. This usually results in an automatic revocation of the authorized address.
6. Conversation—An email thread among a plurality of participants created by replying and replying to all.
7. Envelope header—The headers that form the part of the SMTP exchange including MAIL FROM: and RCPT TO: as defined in RFC 821
8. Message header—The headers that are part of the email message such as Message-ID, Subject and BCC defined in RFC 822
9. Domain or domain name—Internet domain name such as example.com
10. Regular expressions—A concise and flexible means for matching strings of text. As used herein, refers to regular expressions that are designed to match multiple email addresses.
11. Open Authorized address—An authorized address that accepts emails from any sender, easily implemented by setting its assignee to the regular expression .*@.*
12. SMS or SMS text—Short Message Service is the text communication service component of phone, web, or mobile communication systems that allow the exchange of short text messages between fixed line or mobile phone devices.
13. CAPTCHA—Completely Automated Public Turing test to tell Computers and Humans Apart is a type of challenge response test used to ensure that the response is not generated by a computer, usually by requiring a human to read distorted text or image.
14. Bluetooth—is an open wireless technology standard for exchanging data over short distances.

### SUMMARY OF THE INVENTION

A key aspect of the present invention is that having an address per contact (or related set of contacts) instead of a fixed email address allows the system to detect a leak in case it falls into the hands of a spammer and can automatically disable the address.

The present invention is a method and system to transparently generate or manually allocate an authorized email address per contact and accept email sent to the authorized email address from the contact. This ensures that even if an authorized email address is leaked, it will be detected quickly, revoked and the assignee of the authorized email will be notified.

Emails from all authorized addresses are organized into the Inbox or various folders as necessary.

Further, when one of the user's contacts has sent an email to a plurality of addresses including an authorized address, to allow replies from all addresses in the conversation but only to continue the conversation and not additional new conversations.

Further, the user can generate a few open addresses that can receive email from any address. Further, the user is able to restrict an open address to a contact or sender or domain or a plurality thereof. This allows the user to post email addresses on print or electronic publications and websites to allow readers to send email. This address could be revoked after a certain point in time or expire after an allocated lifetime.

### BRIEF DESCRIPTIONS OF THE DRAWINGS

FIG. 1 is an overview of the system and a possible embodiment of the data stored and used by the system

FIG. 2 is a flowchart describing the method of sending emails to a plurality of contacts

FIG. 3 is a flowchart describing the method of receiving emails and determining what emails are acceptable and also keeps track of conversations between a plurality of users.

FIG. 4 is a flowchart describing the method of generating and revoking authorized addresses for user's contacts.

FIG. 5 illustrates a possible embodiment for requesting an authorized address from a user.

FIG. 6 is a possible embodiment of the user's inbox illustrating the usage of various aspects of this invention.

### DETAILED DESCRIPTION OF THE INVENTION

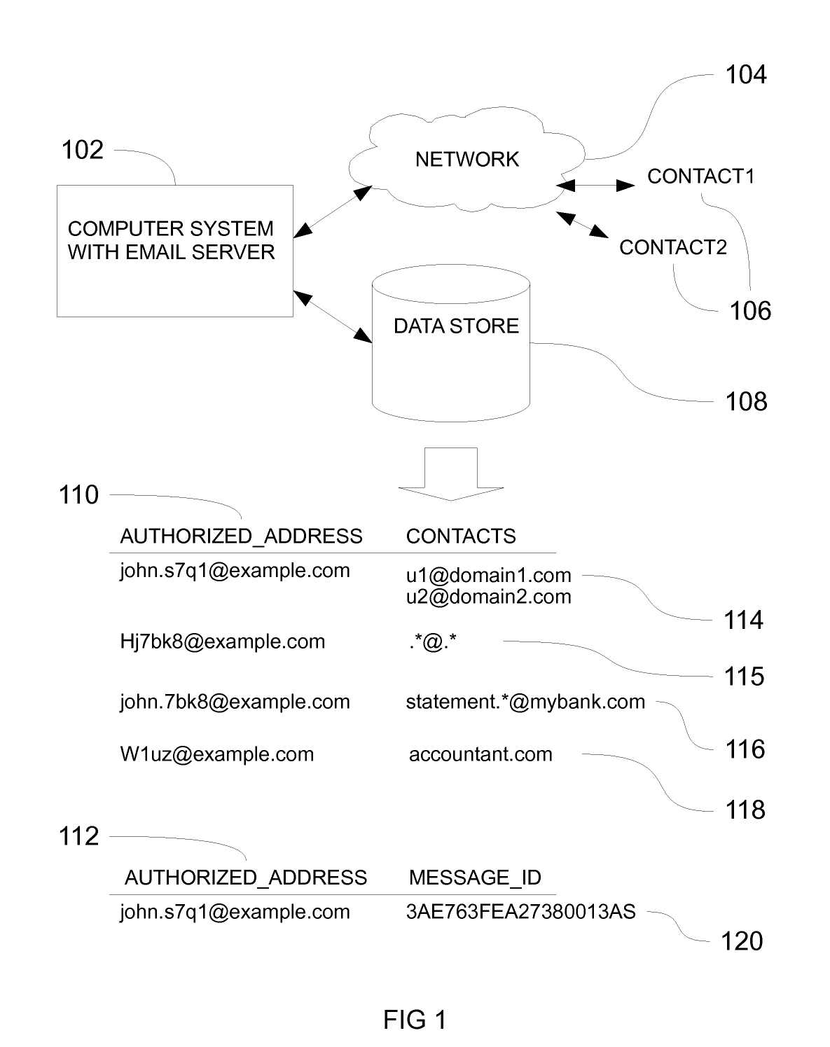

According to FIG. 1. the system consists of a email receiving and processing system consisting with an email server designated by the reference numeral 102 connected to a computer network 104 which may include without limitation, the internet, a LAN, or a wireless data network. The email server is a plurality of processes that accept requests to send and receive email which may include without limitation, an SMTP server and a filter process that could be part of the SMTP server or a separate process that co-operates with the SMTP server in determining the acceptability of the incoming emails that are sent by user's contacts 106 across the network. The system also contains a data store 108, that could be without limitation a relational database, a NoSQL store or simply a text file that stores the authorized email addresses 110 and a plurality of email addresses of user's contacts 114 that are permitted to send emails to the corresponding authorized address. The contact's email addresses could be represented as a set of email addresses using without limitation, a regular expression 116 or simply a domain name 118. Regular expressions and domain names are useful for a variety of reasons, for example to register on a website and receive all emails from the website at a specified authorized address or authorize all emails from a corporate client without requiring to assign an authorized address to every person in the corporation. A regular expression that matches every email address 115 could be used as an open email id that could be used temporarily to receive emails for a short duration, for example to advertise a yard sale or to receive messages in response to a publication. In addition, the system could optionally be instructed to change the assignee to the first contact who sends an email to the said authorized address. This allows the system to enable exchange of authorized addresses using a software handshake process between two users of the system.

The authorized address could be any string of characters followed by the ‘@’ symbol and domain name of the email system and does not need to be prefixed or suffixed by the user's login or other id on the system. A particular embodiment of the invention may choose to combine the user's id as a prefix or suffix for ease of implementation if it chooses to.

Any authorized email could be set to expire after a user specified date or kept open until the user specifically revokes it.

Still referring to FIG. 1, the data store also tracks group conversations 112 by storing the message id 120 from the SMTP message header ‘In-Reply-To’ or ‘References’ when one of the user's contacts sends an email to multiple recipients, one of which is the user of this email system. This is done to allow other recipients to send a reply and continue the group conversation without the need to have an authorized address in the authorized contacts list 110. The system may choose to impose additional restrictions such as limit emails from only the recipients in the original thread or expire group conversations after a user specified period of time.

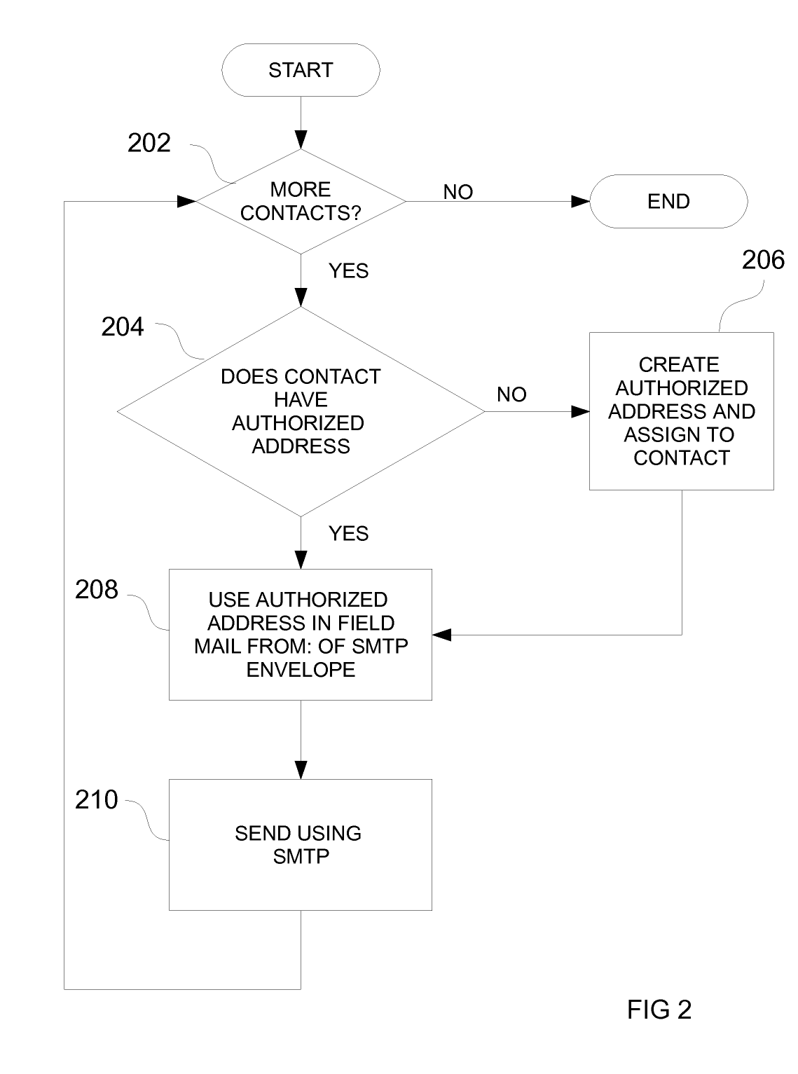

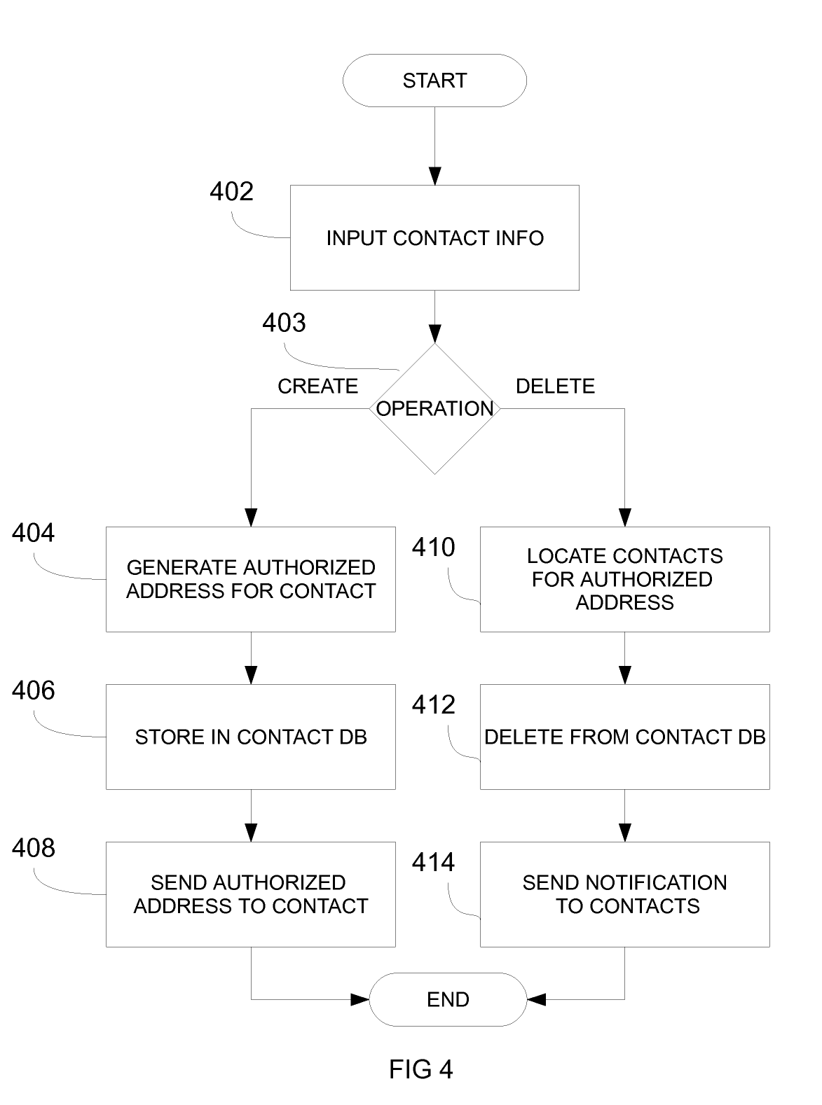

FIG. 2 depicts a preferred method to send email using the system depicted in FIG. 1. The user would enter a plurality of email addresses in the To: CC: and BCC: fields. The system would iterate through each contact 202 and look up its authorized address 204 from the data store 110. If none are found, a new one is created and stored 206 (depicted in detail in FIG. 4.) and is used. If more than one is found, the system may pick any one arbitrarily or pick one that minimizes the number of authorized addresses to send out based on the set of all recipients and uses it in the MAIL FROM: header of the SMTP envelope 208 and the From: message header. The email is then transmitted over SMTP 210. This process is repeated for all recipients of the email. For example, if an email is being sent to three contacts and all three of them have a common authorized address, the system may choose to use that over any other additional authorized addresses the contacts may have. Note that the actual selection does not impact the usability of the system.

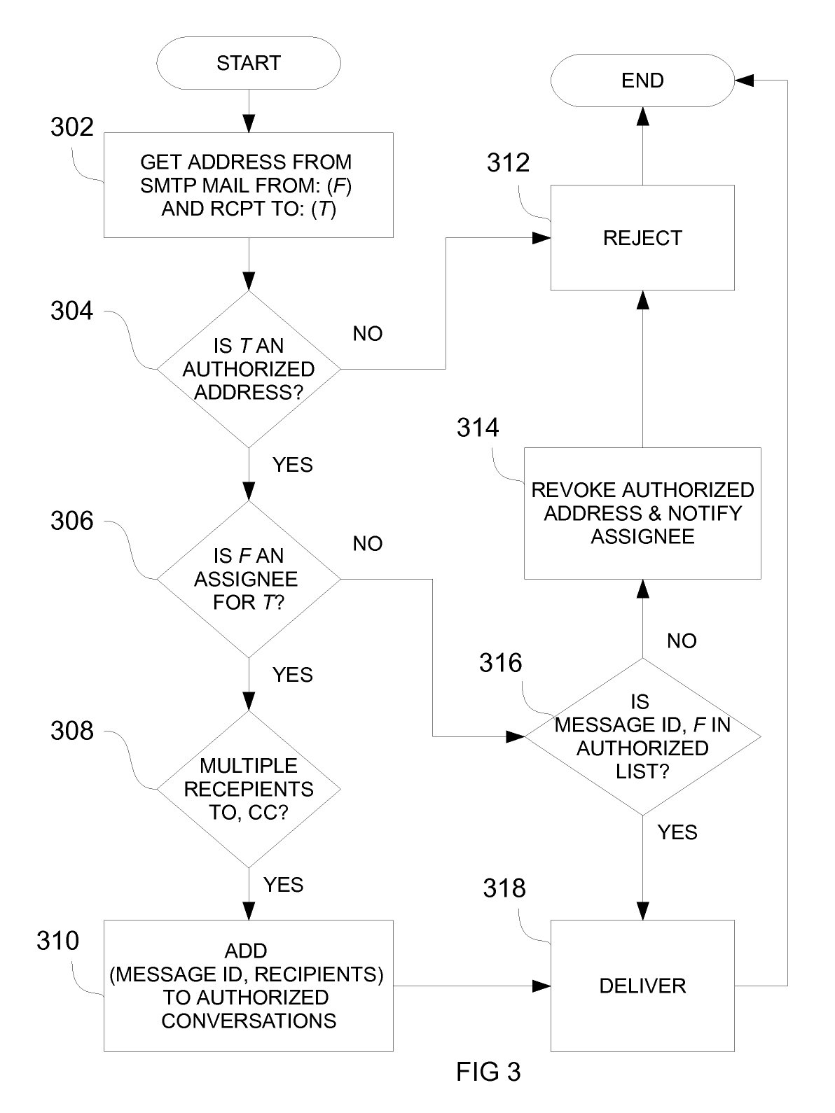

FIG. 3. depicts a preferred method to receive and process incoming emails using the system depicted in FIG. 1. When an SMTP connection is received, the system will process normally and read the MAIL FROM: and RCPT TO: envelope headers 302. At this point the mail server process or a helper filter process examines the email address in the RCPT TO: header and checks to see if its an authorized address 304. If not, the server can reject the email 312 for example by choosing to emit an SMTP 550 ‘Error Address Unknown’ and terminate the connection. The advantage of this approach is reduced bandwidth and processing cost since the actual contents and possible attachments are not read.

If on the other hand, the RCPT TO: contains a valid authorized address, the system checks to see if the sender is a valid assignee for the authorized address 306. If so, then the message is valid. If there are recipients other than the user, the message id and if desired, the list of recipients needs to be noted down 310 and stored in the data store 112 so that if any of them replies to this email, their messages should be allowed. The email is then delivered 318 to the user's Inbox.

If the sender is not an assignee for the authorized address, but the message id in the ‘References’ or ‘In-Reply-To’ matches an entry in the data store 112, then the message is part of a group conversation thread and is determined to be valid 316 and delivered 318 to the user's Inbox. If there is no matching message id, then the contact's authorized email has been leaked and the system revokes the authorized address 314 and notifies the contact 314. The email is rejected 312.

FIG. 4. depicts the creation and deletion of authorized address and assignment to contacts either automatically triggered as part of processing email transmission and receiving as described in FIGS. 3 and 4 or manually by the user or programmatically as in expiry processing. It may be desirable for method to be implemented as a separate process so that both the email processing system and the user interface application can interact with this process independently.

The contact's identifying information such as email address is obtained 402 from either the email processing system or the user interface. If the requested operation 403 is to create an authorized address, a new one is created 404 and stored in the data store 406 as described in 110. A notification containing the details of the authorized address is sent to the contact 408. This could include without limitation, sending an email to the contact's email address or a SMS text message. If the requested operation 403 is deletion, the contacts matching the specified authorized address are located 410 and deleted from the contact DB 412. A notification is optionally sent to the contacts 414 informing them that their authorized address has been revoked.

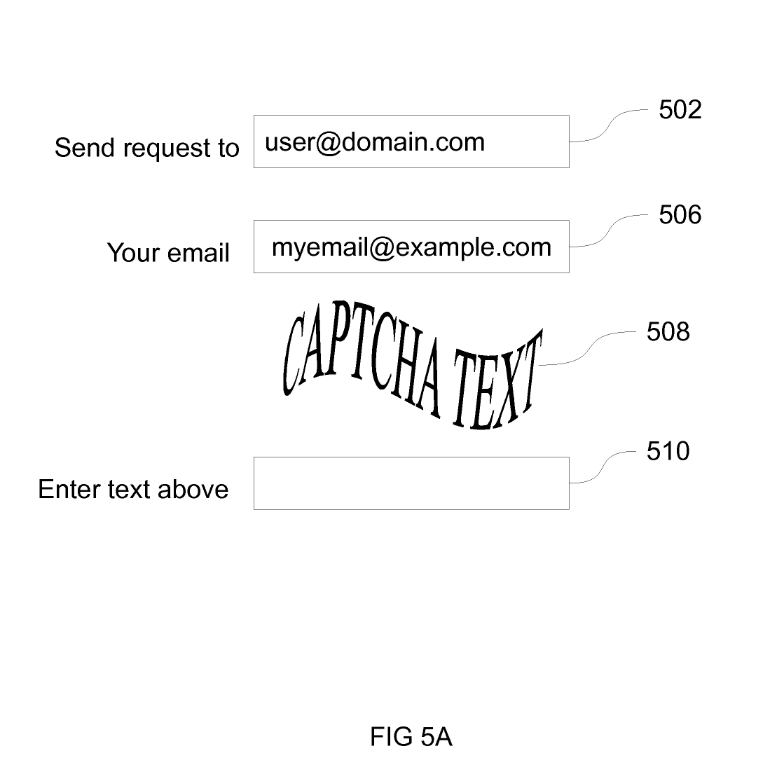

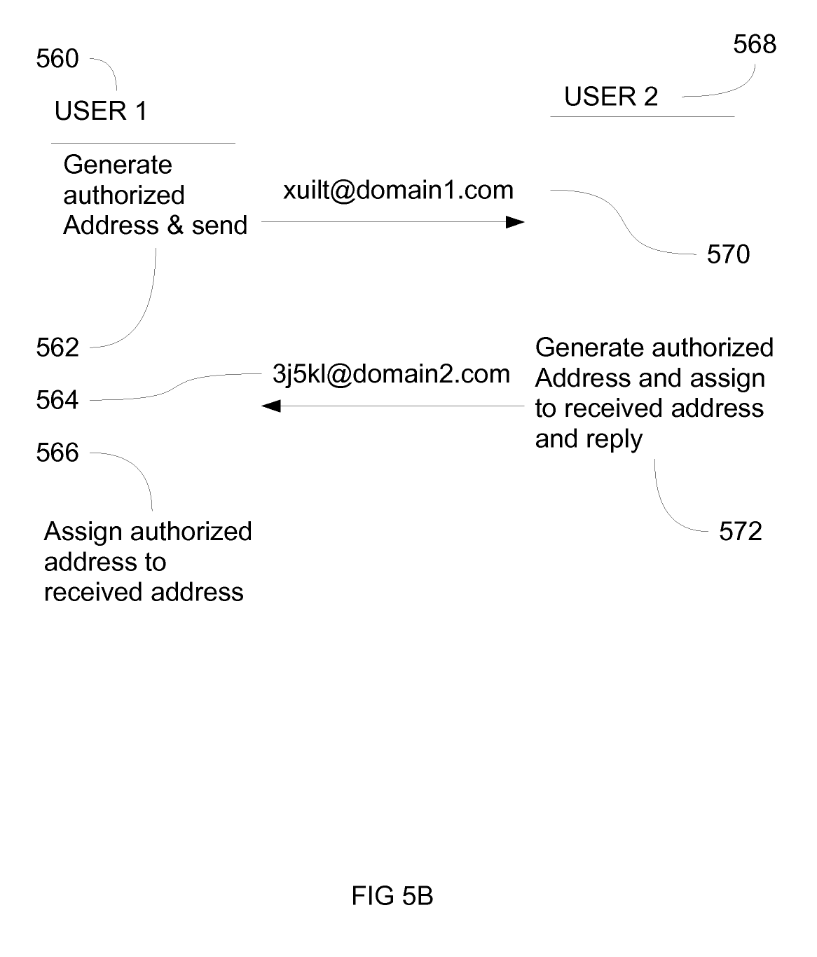

FIG. 5A depicts a possible embodiment of how a new contact may request an authorized address to send emails to a user of the system. The contact could go to a web page that allows the contact to input the user's identifier 502 and the email address 506 that the authorized address should be sent to. Optionally, the web page could present a CAPTCHA test 508 and proceed only on a correct answer 510 to restrict abuse of the authorization request system. If the contact also happens to be a user on a similar email system, he can pre-generate an authorized email that's assigned to any email from the expected domain and place it in the email address field 506. When he receives a notification from the new authorized address, he can restrict it to the new address. The user interface is expected to make most of these transparent to the user. The user identifier 502 does not necessarily need to be an email address. It could be any character string that uniquely identifies the user to the system such as an account number or alphanumeric user id or a placeholder email address that is not really a valid email address in the system, but one whose purpose is to uniquely identify the user.

FIG. 5B depicts a possible embodiment of how two users of the system or compatible systems can exchange authorized addresses using a software process. This process may be implemented for example, as an application on a smartphone or hand-held device capable of sending and receiving SMS text, bluetooth communication or any other form of device to device communication. The first user 560 initiates the handshake process on his smartphone application by entering the an identifier for the second user 568 such as a user-id on the email system, a phone number for SMS, a PIN for bluetooth, etc. The application generates an unassigned authorized address 570 and sends it over 562 to the second user's device. On receiving the authorized address from the first user, the application running on the second user's device extracts the address and assigns it to a newly generated authorized address 564 and sends it 572 to the first user. The first user's application extracts this address 564 and assigns the authorized address 570 to it. If no reply is received within a specified amount of time, the first user's authorized address 570 can be set to expire in order to avoid leaving invalid authorized addresses in the system.

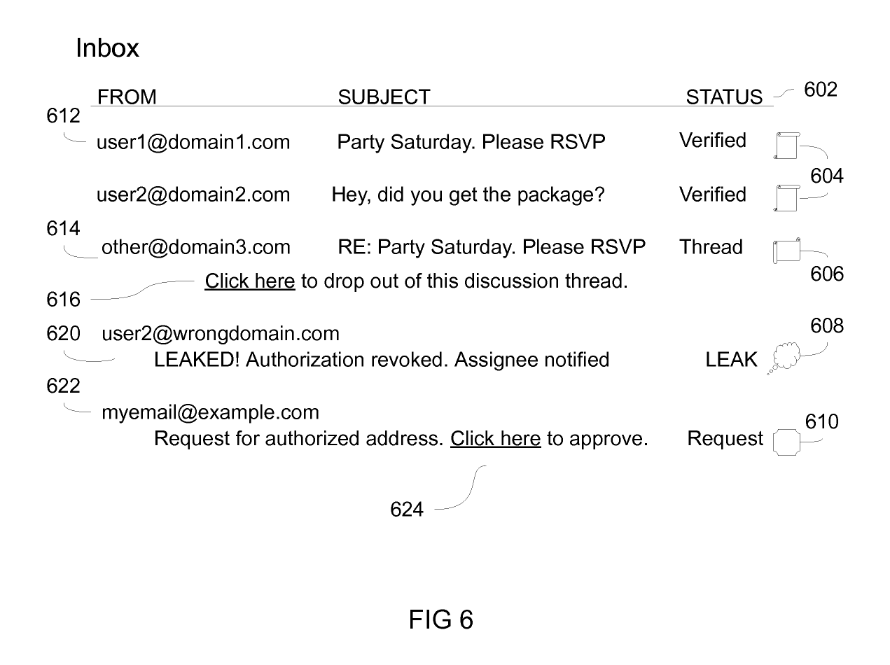

FIG. 6. depicts a possible embodiment of a user interface that allows the user to exercise most of the functionality of the system. When an email message is accepted for delivery, it shows up in the users Inbox. The authorization status of the message may be displayed in a column 602 or as an icon 604 or both. An email sent from a member of a group conversation 614 is marked differently 606 to distinguish it from an email sent by an authorized contact 612. The user can choose to simply drop out of the conversation, this would remove the message id 120 from the data store 112 and will prevent further emails from users who are not authorized contacts. If an email message is received from an unauthorized sender 620 then the system will revoke the authorized address and notify the sender. A leaked status 608 is displayed to the user. Authorization requests 620 can also be displayed in the inbox and the user can trigger the generation and transmission of an authorized address by simply clicking a link 624. Optionally, the user can instruct the system to auto-approve requests for contacts whose email addresses are from any or specific set of domains, for example using a regular expression.

Sometimes a user may have a reason to believe that a contact's computer has been compromised by a trojan and would like to revoke the assigned authorized address. In addition, the user may choose to revoke any authorized address for any or no reason by simply requesting the system to delete an authorized address. This would be useful for example, if a prior relationship with a person or corporation has turned stale and the user no longer wishes to receive communications from that person or corporation. This may be achieved for example by simply dragging the authorized address or icon 604 to the Trash folder or icon in the user interface.

The authorization request described in FIG. 5 is of course merely representative. Any convenient request system may be used to facilitate the obtaining of an authorized address without moving away from the spirit of the invention. Similarly, the user interface described in FIG. 6 is also merely representative and one of ordinary skill in the art will recognize that it may be substituted by any convenient interface including without limitation any other text, graphical or touch user interface or command line interface without moving away from the spirit of the invention.

While a preferred embodiment of the invention has been illustrated and described herein, the invention is not limited to the precise construction disclosed and it is to be understood that there could be other embodiments that do not depart from the spirit of the invention. Also flowcharts described here are examples, and there may be many variations to these diagrams without departing from the spirit of the invention. For example, steps may be performed in a different order or steps may be added, removed or modified.

In addition, although the various methods described are conveniently implemented in a general purpose computer, one of ordinary skill in the art would also recognize that such methods may be carried out in hardware, firmware or in specialized appliance constructed to perform the required method steps.

What is claimed is:

1. A system and method for managing undesired email or SPAM, the method comprising of:
a) a mail server running on a computer system connected to a computer network.
b) a user interface that allows users to create a plurality of authorized addresses and assign each of them to a plurality of contacts.
c) a data store that stores authorized email addresses, their respective assignees and message ids
d) The mail server in turn comprising of a plurality of processes that include an SMTP server process and a filtering process
e) The method of sending emails comprising of:
Placing the recipient's authorized address in the ‘From’ and optionally the ‘Reply-To’ SMTP header
Sending the email via the SMTP process.
f) The method of accepting emails comprising of:
accepting emails sent to authorized addresses sent by their respective assignees
accepting emails that are continuing conversations of such emails.
accepting optionally requests by email for new authorized addresses
rejecting any other emails.

2. The method according to claim 1 wherein the computer system is an network appliance.

3. The method according to claim 1 wherein the computer system is virtual machine.

4. The method according to claim 1 wherein the computer system is a handheld device such as smartphone or tablet.

5. The method according to claim 1 wherein the network is the Internet

6. The method according to claim 1 wherein the network is a local area network (LAN)

7. The method according to claim 1 wherein the network is a wide area network (WAN)

8. The method according to claim 1 wherein the network is a virtual private network (VPN)

9. The method according to claim 1 wherein the network is an RF network including without limitation packet radio, bluetooth or wifi.

10. The method according to claim 1 wherein the user interface is rendered on a web browser.

11. The method according to claim 1 wherein the user interface comprises of a plurality of commands that may be typed into a text terminal (tty)

12. The method according to claim 1 wherein the user interface is a touch input device

13. The method according to claim 1 wherein the user interface comprises of a plurality of commands that may be spoken into a voice command accepting device.

14. The method according to claim 1 wherein the filter process and the SMTP server is integrated into a single process.

15. The method according to claim 1 wherein the data store is a relational database

16. The method according to claim 1 wherein the data store is a noSQL database.

17. The method according to claim 1 wherein the data store is a text file.

18. The method according to claim 1 wherein the data store permits contact's email addresses stored as regular expressions.

19. The method according to claim 1 wherein the data store permits contact's email addresses to be a domain name to allow any email address from the said domain to be an assignee for the corresponding authorized address.

20. The method according to claim 1 wherein the authorized emails are set to expire on a specific date and time or after a pre-determined amount of time past creation.

21. The method according to claim 1 wherein an authorized address is automatically created and assigned when the user sends an email to a contact who does not have any assigned authorized address.

22. The method according to claim 1 wherein an open authorized address is automatically assigned to the first contact who sends an email to the said address.

23. The method according to claim 1 wherein the message id from ‘Reply-To’ or ‘References’ header of an email communication from a contact is stored and optionally the co-recipients noted for future continuation of the email conversation thread among all parties.

24. The method according to claim 1 wherein a leak of an authorized address is detected if the email is sent from anyone other than the assigned contact.

25. The method according to claim 1 wherein the leaked authorized address is automatically revoked by the system or revoked by the user after notification.

26. The method according to claim 1 wherein the user may delete an authorized address by dragging the address or an icon representation to the Trash folder or Trash icon.

27. The method according to claim 1 wherein a contact may request an authorized address from a web application or internet site.

28. The method according to claim 1 wherein the contact may request an authorized address by sending an SMS text message.

29. The method according to claim 1 wherein users can mutually authorized addresses by generating new authorized addresses and exchanging them over device to device communication.

30. The method according to claim 1 wherein the user can instruct the system to auto-approve requests for authorized addresses made on a website or sent via an SMS text message.

31. The method according to claim 1 wherein the user can instruct the system to auto-approve requests for authorized addresses for contacts whose email addresses match a regular expression or those that belong to a plurality of pre-determined internet domain names.
